(19) United States
(12) Patent Application Publication
(10) Pub. No.: US 2016/0175757 A1
(43) Pub. Date: Jun. 23, 2016

(54) AIR WASHER

(71) Applicant: WINIX INC., Gyeonggi-do (KR)

(72) Inventor: Hee Jong YOON, Seoul (KR)

(73) Assignee: Winix Inc., Gyeonggi-do (KR)

(21) Appl. No.: 14/909,870

(22) PCT Filed: Aug. 1, 2014
(86) PCT No.: PCT/KR2014/007107

§ 371 Date: Feb. 3, 2016

(30) Foreign Application Priority Data
Aug. 2, 2013 (KR) 1020130092168

(51) Int. Cl. B01D 47/18; F24F 13/20; F24F 6/06

(52) U.S. Cl. CPC B01D 47/18; F24F 6/06; F24F 13/20; F24F 2006/065; F24F 2006/008

(57) ABSTRACT

An air washer in which a water tank unit may be pulled out in a frontward direction is provided, in which a water container to supply water to the water tank unit may be omitted, water may be supplied by directly pulling out the water tank unit in the frontward direction instead, and a front panel or a shielding panel may be used to shield a space formed between the water tank storage portion and the water tank unit when the water tank unit is stored in the water tank storage portion.

### TECHNICAL FIELD

Embodiments of the present invention relate to an air washer that humidifies and washes air, and more particularly, to an air washer that directly stores water in a water tank in which a disk assembly is provided.

### BACKGROUND ART

In general, an air washer refers to a device that humidifies and washes air by contacting air with water. A type of the air washer may vary based on a method of contacting air with water. For example, the air washer may include an air washer that sprays water over air, an air washer that has air pass through a wet filter, and an air washer that blows air toward a disk in which a water film is formed.

Recently, active development of technology related to a disk type air washer is ongoing. The disk type air washer has advantages of less noise, small size, condensation-free humidification, and exemption from filter replacement.

Korean Patent No. 10-0757407 (hereinafter R1), entitled “Disk and disk assembly for air washer”, registered on Sep. 4, 2007, discloses a disk type air washer. In R1, a lower portion of the air washer may be formed directly by a water container, and a disk assembly may be provided in an internal portion of the water container. To refill the water container with water or wash the water container and the disk assembly, a process of separating a top case and a middle case constituting an upper portion of the air washer from the water container and assembling the separated components may be iteratively performed. Thus, tasks of refilling or washing may be overly complex and inconvenient, and the components may be damaged, lost, and incorrectly assembled during the process of separating and re-assembling the components.

Japanese Patent Application Publication No. 2006-057995 (hereinafter R2), entitled “Humidifier”, published on Mar. 2, 2006, discloses a structure in which a tank may be pulled out in a frontward direction from a humidifier body. However, R2 relates to a filter type humidifier rather than a disk type humidifier, and a structure in which a water supply tank to supply water to a water container is applied. In R2, separation of the water supply tank may be performed in advance of pulling out the water container. Thus, a task of pulling out the water container may be complex, and a possibility of decomposition or contamination of water stored in the water supply tank may increase when the water supply tank is used for a long time.

### DISCLOSURE OF INVENTION

### Technical Goals

An aspect of the present invention provides an air washer in which a water tank unit may be conveniently pulled out in a frontward direction from an air washer body, and a water container to supply water to the water tank unit may be omitted.

Another aspect of the present invention provides an air washer that may improve esthetics of an appearance thereof by completely shielding a water tank storage portion in which a water tank unit and a disk assembly are stored when the water tank unit is stored.

Still another aspect of the present invention provides an air washer that may be free from restrictions on a size of a water tank unit and use a large-capacity disk assembly.

### Technical Solutions

According to an aspect of the present invention, there is provided an air washer including an air washer body including an air inlet and an air outlet, an air blowing unit provided in an internal portion of the air washer body to draw in air through the air inlet and exhaust air through the air outlet, a disk assembly disposed on an air flow path between the air inlet and the air outlet to humidify and wash the air drawn in by the air blowing unit, and a water tank unit including a water receiving portion in which the disk assembly is disposed to be movable, and provided in a lower portion of the air washer body to be pulled out in a frontward direction of the air washer body.

In the air washer, the water tank unit and the disk assembly may be conveniently pulled out in a frontward direction of the air washer body, whereby supplying water to an internal portion of the water tank unit and cleaning of the water tank unit and the disk assembly may be conveniently performed. Thus, a water container to supply water to the internal portion of the water tank unit may be omitted from the air washer.

A water tank storage portion opening in a frontward direction may be formed in the lower portion of the air washer body. The water tank unit may be disposed to be slidingly moved in the water tank storage portion.

The disk assembly may be formed in a size to enable a portion thereof to be exposed in an upper portion of the water tank unit. The water tank storage portion may be formed in a size to prevent interference with the disk assembly when the water tank unit is pulled out and stored.

The air washer may further include a shielding panel formed to protrude on a front surface portion of the water tank unit to shield a space between the water tank unit and the water tank storage portion.

The air washer may further include a front panel provided to be rotatable or movable on a front surface portion of the air washer body. The front panel may be disposed on the front surface portion of the air washer body to form a front surface of the air washer when the water tank unit is stored, and may be rotated or moved to a location to completely open the water tank storage portion when the water tank unit is pulled out.

The front panel may be provided in a hinged door type on the front surface portion of the air washer body, and may be rotatably opened and closed in a vertical direction or a horizontal direction. In another example, the front panel may be provided in a sliding door type on the front surface portion of the air washer body, and may be movably opened and closed in a vertical direction or a horizontal direction. In still another example, the front panel may be provided in a clock type on the front surface portion of the air washer body, and may be rotatably opened or closed in a clockwise direction or a counterclockwise direction.

The front panel may be formed to cover the front surface portion of the air washer body, a front surface portion of the water tank unit, and a space between the water tank unit and the water tank storage portion. In another example, the front panel may be formed to cover the front surface portion of the air washer body, and a space between the water tank unit and the water tank storage portion. In still another example, the front panel may be formed to cover a space between the water tank unit and the water tank storage portion when the water tank unit is stored.

A single front panel or a plurality of front panels may be disposed on the front surface portion of the air washer body.

The air washer may further include an elastic member provided on the front panel and the air washer body to provide an elastic force to the front panel in an opening direction of the front panel, and a locking device provided on the front panel to lock the front panel on the front surface portion of the air washer body.

The locking device may be formed to cancel a lock state in response to a movement of the water tank unit when the water tank unit is pulled out. In another example, the locking device may be formed to cancel a lock state by operating an operating portion formed on the air washer body or the front panel before the water tank unit is pulled out.

The air inlet may be formed on both a rear surface portion of the air washer body and the front panel, and the air outlet may be formed on a top surface portion of the air washer body. In this example, an air guide may be formed on the front panel and the rear surface portion of the air washer body to guide the air drawn in through the air inlet to the disk assembly.

According to another aspect of the present invention, there is also provided an air washer including an air washer body to humidify and wash air, a water tank unit disposed in a lower portion of the air washer body to be pulled out in a frontward direction of the air washer body, and including a water receiving portion to receive water to be used to wash air, and a front panel disposed on a front surface portion of the air washer body, and provided to be rotated or moved to a location away from a pulling-out path of the water tank unit when the water tank unit is pulled out.

The air washer may further include a disk assembly disposed on an air flow path in an internal portion of the air washer body. The disk assembly may be disposed to be rotatable in the water receiving portion, and may be pulled out in the frontward direction of the air washer body along with the water tank unit.

A water tank storage portion opening in a frontward direction may be formed in a lower portion of the air washer body. The water tank unit may be disposed to be slidingly moved in the water tank storage portion. The front panel may be formed to open and close the water tank storage portion.

The front panel may be provided in at least one of a hinged door type, a sliding door type, and a clock type on the front surface portion of the air washer body to open and close the water tank storage portion.

At least one of an air inlet and an air outlet may be formed on the front panel.

An air guide may be formed on a rear surface of the front panel to guide air drawn in through the air inlet or air to be exhausted through the air outlet.

### Advantageous Effects

According to an embodiment of the present invention, an air washer may be provided in a structure in which a water tank unit may be conveniently pulled out in a frontward direction from a lower portion of an air washer body, whereby refilling a water receiving portion of the water tank unit with water may be conveniently performed. Thus, a water container used in a related art to provide water to the water receiving portion may be omitted, whereby an increase in costs for use of the water container and an increase in a size of the air washer may be prevented, and a task to separate a water container may be omitted when the water tank unit is pulled out.

According to an embodiment of the present invention, an air washer may be provided in a structure in which a water tank unit in which a disk assembly is disposed may be pulled out in a frontward direction from a lower portion of an air washer body, whereby cleaning and maintaining the water tank unit and the disk assembly may be conveniently performed.

According to an embodiment of the present invention, an air washer may be provided in a structure in which a shielding panel or a front panel may completely shield a water tank storage portion when a water tank unit is stored, whereby esthetics of an appearance of the air washer may be improved and a commercial value of the air washer may increase.

According to an embodiment of the present invention, an air washer may be provided in a structure in which a shielding panel or a front panel may completely open a water tank storage portion when a water tank unit is pulled out, whereby the water tank unit may be smoothly pulled out along with a disk assembly, a size of the disk assembly may increase maximally, and a performance of the air washer may increase.

According to an embodiment of the present invention, an air washer may apply various designs and opening and closing methods of a front panel based on design conditions, surroundings, or recent trends, whereby a line-up of air washers having various appearances may be established based on customer preferences.

According to an embodiment of the present invention, an air washer may actively handle a decrease in esthetics thereof due to a long-term usage since a front panel may be replaceable, and sales of front panels may establish a new business field.

According to an embodiment of the present invention, an air washer may be provided in a structure in which a front panel may be quickly and conveniently opened only by moving a water tank unit when the water tank unit is pulled put, or a front panel may be conveniently opened by operating an operating portion immediately before a water tank unit is pulled out. Thus, an inconvenience in use of the front panel may be minimized, and a convenience in pulling out and storing the water tank unit may increase.

### BRIEF DESCRIPTION OF DRAWINGS

FIG. 1 is a perspective view illustrating an air washer according to an embodiment of the present invention.

FIG. 2 is a right cross-sectional view illustrating a lower portion of the air washer of FIG. 1.

FIG. 3 is a right side view illustrating an operating state when a water tank unit is pulled out from the air washer of FIG. 1.

FIG. 4 is a cross-sectional view of a portion A of FIG. 3.

FIGS. 5 through 8 are views illustrating modified examples of the air washer of FIG. 1.

FIG. 9 is a perspective view illustrating an air washer according to another embodiment of the present invention.

FIG. 10 is a right cross-sectional view illustrating a lower portion of the air washer of FIG. 9.

FIGS. 11 through 14 are views illustrating modified examples of the air washer of FIG. 9.

FIG. 15 is a front view illustrating an air washer according to still another embodiment of the present invention.

FIG. 16 is a side view illustrating an air washer according to yet another embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

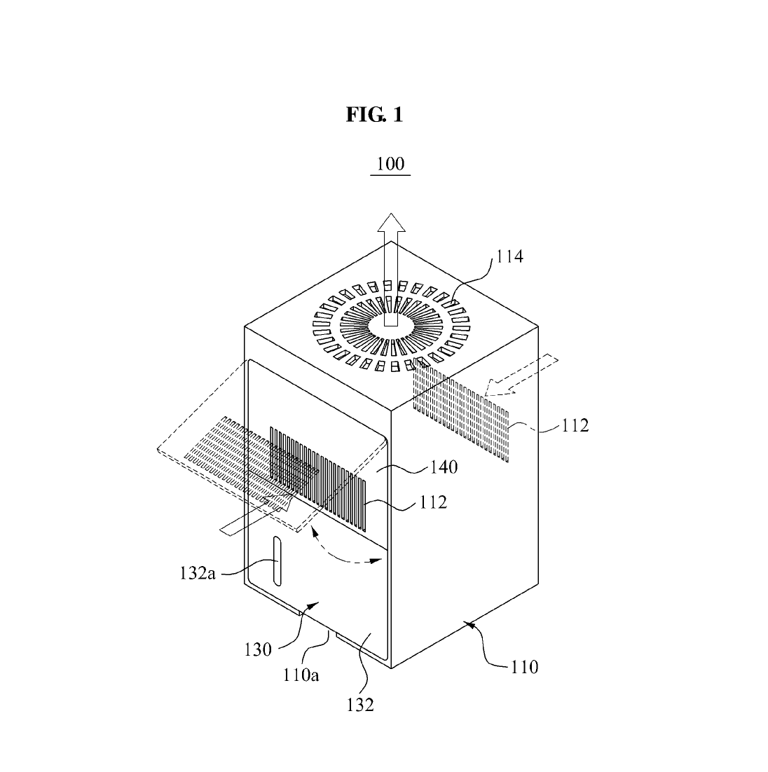

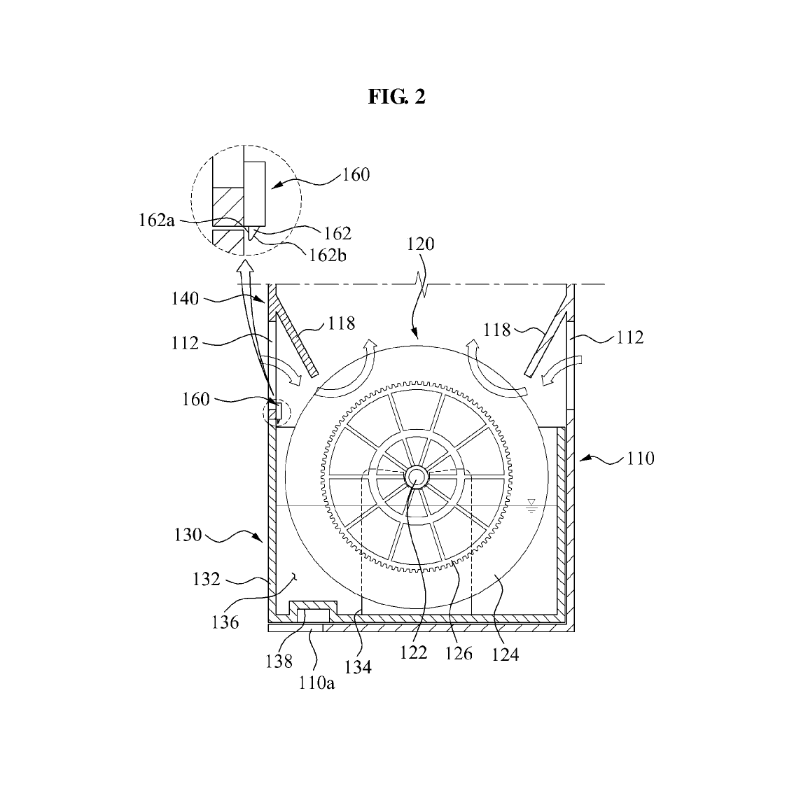

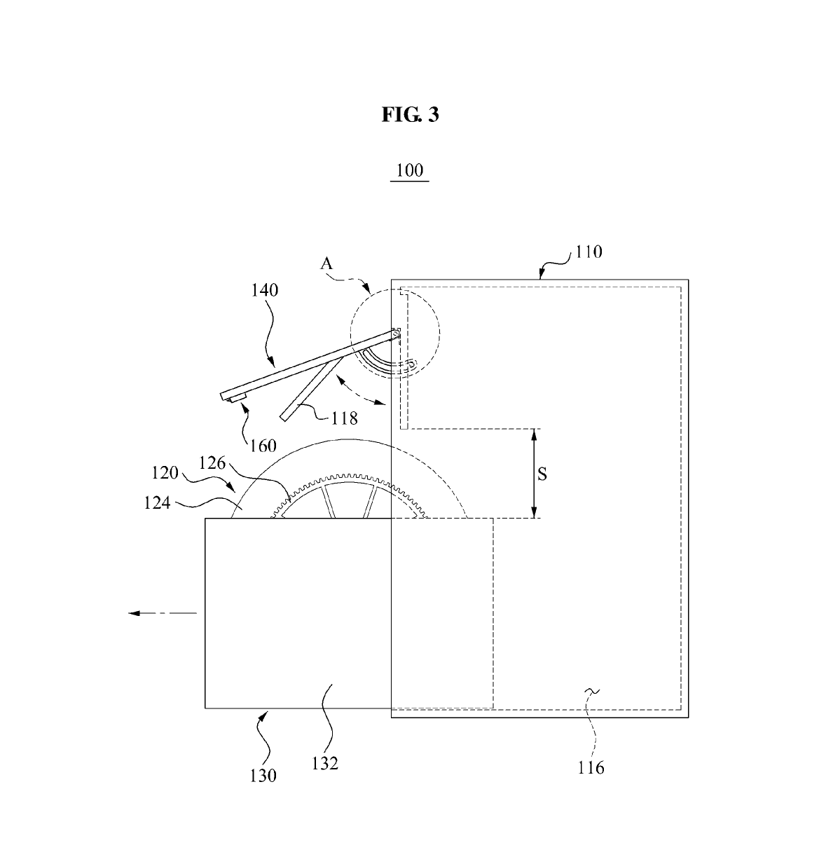

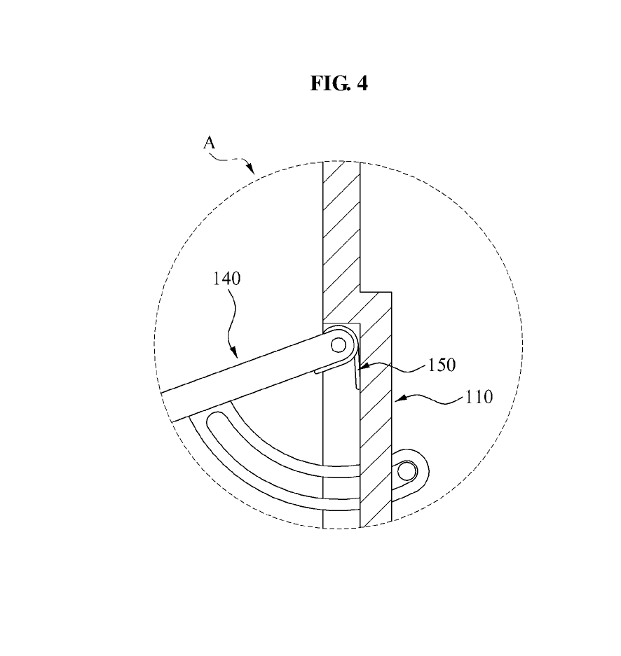

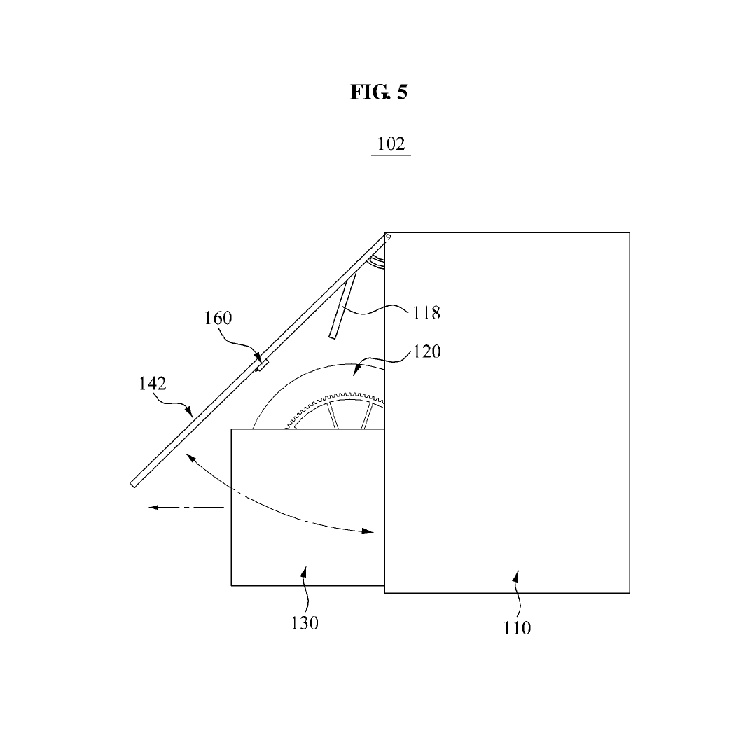

FIG. 1 is a perspective view illustrating an air washer 100 according to an embodiment of the present invention. FIG. 2 is a right cross-sectional view illustrating a lower portion of the air washer 100 of FIG. 1. FIG. 3 is a right side view illustrating an operating state when a water tank unit 130 is pulled out from the air washer 100 of FIG. 1. FIG. 4 is a cross-sectional view of a portion A of FIG. 3. FIGS. 5 through 8 are views illustrating modified examples of the air washer 100 of FIG. 1.

Referring to FIGS. 1 through 3, the air washer 100 may include an air washer body 110, an air blowing unit (not shown), a disk assembly 120, and the water tank unit 130.

The air blowing unit may be configured to draw external air into an internal portion of the air washer 100, and exhaust air processed by the air washer 100 out of the air washer 100. The air blowing unit may include a blower to forcibly blow air, and a shroud disposed in a vicinity of the blower. Hereinafter, the air blowing unit is not directly related to features of the present invention and thus, detailed descriptions on a configuration thereof will be omitted.

The air washer body 110 may be formed to have an appearance similar to a box. The air blowing unit, the disk assembly 120, and the water tank unit 130 may be received in the air washer body 110.

The air washer body 110 may include an air inlet 112 and an air outlet 114. External air may be drawn through the air inlet 112 into the air washer body 110. The air inlet 112 may be formed on both a rear surface portion of the air washer body 110 and a front panel 140. Humidified and washed air may be exhausted through the air outlet 114 out of the air washer body 110. The air outlet 114 may be formed on a top surface portion of the air washer body 110.

The air blowing unit may be disposed on an air flow path formed between the air inlet 112 and the air outlet 114. Hereinafter, the air blowing unit will be described to be disposed below the air outlet 114. However, an embodiment of the present invention is not limited thereto. The air blowing unit may be provided at various locations depending on design conditions and situations.

A water tank storage portion 116 opening in a frontward direction may be formed in a lower portion of the air washer body 110. The water tank storage portion 116 is a space to store the water tank unit 130. The water tank unit 130 may be disposed to be slidingly moved in the water tank storage portion 116.

An air guide 118 may be formed on the front panel 140 and the rear surface portion of the air washer body 110 to guide the air drawn in through the air inlet 112 to the disk assembly 120. The air guide 118 may be formed on the front panel 140 or the rear surface portion of the air washer body 110 to protrude and incline toward the disk assembly 120 in the air washer body 110. A top end portion of the air guide 118 may be disposed at a location higher than the air inlet 112, and a bottom end portion of the air guide 118 may be disposed at a location close to the disk assembly 120.

The disk assembly 120 may be configured to humidify and wash the air drawn in by the air blowing unit. Thus, the disk assembly 120 may be disposed on the air flow path between the air inlet 112 and the air outlet 114.

The disk assembly 120 may include a disk shaft 122, a disk plate 124, and a driving plate 126.

The disk shaft 122 may be disposed to be rotatable on a shaft support portion 134 of the water tank unit 130. The disk plate 124 and the driving plate 126 may be mounted and fastened on the disk shaft 122. Thus, the disk plate 124 and the driving plate 126 may rotate along with the disk shaft 122.

A plurality of disk plates 124 may be disposed to be spaced from one another other on the disk shaft 122. Lower portions of the disk plates 124 may be sunk under water in the water tank unit 130. When the disk plates 124 rotate along with the disk shaft 122, water films may be formed on surfaces of the disk plates 124. Humidification and washing may be performed through a process of contacting the air drawn in through the air inlet 112 with the water films of the disk plates 124.

An external driving power may be input into the driving plate 126. A gear portion into which the driving power is input may be formed along an outer circumference of the driving plate 126. The driving plate 126 may be disposed next to the disk plates 124.

The water tank unit 130 may be configured to store water to be used in the air washer 100. The disk assembly 120 may be disposed to be rotatable in an internal portion of the water tank unit 130. The water tank unit 130 may be stored in the water tank storage portion 116, and pulled out in the frontward direction of the air washer body 110.

The water tank unit 130 may include a water tank body 132 and the shaft support portion 134.

The water tank body 132 is a member in a shape of a box in which water is stored. A water receiving portion 136 may be formed in an internal portion of the water tank body 132 to receive water therein. A transparent window 132a may be formed on a front surface portion of the water tank body 132 to verify a level of water stored in the water receiving portion 136. The water tank body 132 may be disposed in the internal portion of the water tank storage 116 to be pulled out in a frontward direction.

A handle portion 138 to be used to pull out the water tank unit 130 may be formed in a front portion of a bottom surface portion of the water tank body 132. A handle recess 110a may be formed at a location corresponding to the handle portion 138 in a front portion of a bottom surface portion of the air washer body 110. In a case in which the water tank unit 130 is stored in the water tank storage portion 116, the water tank unit 130 may be conveniently pulled out in the frontward direction of the water tank storage portion 116 by pulling the water tank unit 130 the frontward direction with a hand in the handle portion 138 through the hand recess 110a. The handle portion 138 may be disposed at an out-of-sight location to improve a design of the air washer 100.

The shaft support portion 134 is a member to support both end portions of the disk shaft 122 to be rotatable. The shaft support portion 134 may be formed on both sides of the water receiving portion 136. Thus, the disk assembly 120 may be disposed to be rotatable in the internal portion of the water receiving portion 136.

As illustrated in FIGS. 2 and 3, the lower portions of the disk plates 124 may be sunk under water in the water receiving portion 136, and upper portions of the disk plates 124 may be exposed in an upper portion of the water receiving portion 136. The disk assembly 120 may be disposed in the internal portion of the water receiving portion 136, and sizes of the disk plates 124 may be designed to dispose the upper portions of the disk plates 124 at a location higher than the water tank body 132. As the sizes of the disk plates 124 increase, humidification and washing performance of the air washer 100 may increase.

When the sizes of the disk plates 124 increase, the water tank storage portion 116 may be expanded to a height that prevents interference with the disk plates 124 in a case in which the water tank unit 130 is pulled out. Thus, when the water tank unit 130 is stored in the water tank storage portion 116, a space S corresponding to a height difference between the disk assembly 120 and the water tank unit 130 may be formed on a front surface of the air washer 100 between the water tank unit 130 and a top end portion of the water tank storage portion 116.

The air washer 100 may further include the front panel 140 provided to be rotatable or movable on the front surface portion of the air washer body 110. As described above, the air inlet 112 may be formed on the front panel 140, and the air guide 118 may be formed on a rear surface of the front panel 140 to be inclined toward the disk assembly 120.

The front panel 140 may be disposed on the front surface portion of the air washer body 110 to form a front surface of the air washer 100 when the water tank unit 130 is stored. The front panel 140 may be formed to completely shield the space S formed between the water tank storage portion 116 and the top end portion of the water tank body 132. In a case in which the front panel 140 completely shields the space S formed between the water tank unit 130 and the water tank storage portion 116 when the water tank unit 130 is stored, the space S may be out of sight from a front of the air washer 100. Thus, esthetics of an appearance of the air washer 100 may be improved. In addition, an inflow of an external foreign substance through the space S into the internal portion of the air washer 100 may be prevented.

When patterning or paint is added to the front surface of the front panel 140 to enhance the esthetics, the use of the front panel 140 may increase a commercial value of the air washer 100. In addition, the front panel 140 may be replaceable depending on a customer preference. Thus, a customer satisfaction with respect to the appearance and the design of the air washer 100 may increase, and the appearance and the design of the air washer 100 may be quickly changed depending on a recent trend.

The front panel 140 may be rotated or moved to a location to completely open the water tank storage portion 116 when the water tank unit 130 is pulled out. Thus, the water tank unit 130 and the front panel 140 may be disposed at locations to prevent mutual interference. The water tank unit 130 and the disk assembly 120 may be smoothly pulled out in the frontward direction of the water tank storage portion 116 without interference by the front panel 140.

As illustrated in FIGS. 1 through 4, the front panel 140 may be provided in a hinged door type on the front surface portion of the air washer body 110 to be rotatably opened and closed in a vertical direction. The front panel 140 may be formed to cover the front surface portion of the air washer body 110, and the space S between the water tank unit 130 and the water tank storage portion 116.

A top end portion of the front panel 140 may be rotatably hinge-connected to an upper portion of the front surface portion of the air washer body 110. An opening angle of the front panel 140 may be set to be an angle to prevent interference by the water tank unit 130 and the disk assembly 120 when the water tank unit 130 is pulled out.

A bottom end portion of the front panel 140 may be formed to be placed closest to a top end portion of the front surface portion of the water tank body 132 when the water tank unit 130 is stored. Thus, the front panel 140 may cover the front surface portion of the air washer body 110 and the space S between the water tank unit 130 and the water tank storage portion 116. The front surface of the air washer 100 may include the front panel 140 and the front surface portion of the water tank body 132.

Referring to FIGS. 2 through 4, the air washer 100 may further include an elastic member 150 and a locking device 160.

The elastic member 150 is a member to provide an elastic force to the front panel 140 in an opening direction of the front panel 140. The elastic member 150 may be provided on the front panel 140 and the air washer body 110. For example, the elastic member 150 may be configured using a torsion spring provided on a hinge axis of the front panel 140. One end of the torsion spring may be disposed on the rear surface of the front panel 140, and another end of the torsion spring may be disposed on the front surface portion of the air washer body 110.

The locking device 160 is a member to lock the front panel 140 on the front surface portion of the air washer body 110. The locking device 160 may be provided on the rear surface of the front panel 140. For example, the locking device 160 may be configured using a hook 162 to be stopped at the top end portion of the front surface portion of the water tank unit 130 when the water tank unit 130 is stored. The hook 162 may be formed to be elastically pressed. A stopper surface 162a may be formed on one side of the hook 162. The stopper surface 162a may be stopped at the top end portion of the front surface portion of the water tank body 132 while the water tank unit 130 is being stored. An inclined surface 162b may be formed on another side of the hook 162. The inclined surface 162b may elastically run over the top end portion of the front surface portion of the water tank body 132 when the front panel 140 is disposed on the front surface portion of the air washer body 110 after the water tank unit 130 is stored.

A restriction state of the front panel 140 by the locking device 160 may be cancelled with a simple motion of pulling out the water tank unit 130, and the front panel 140 may be automatically opened by the elastic force of the elastic member 150. The front panel 140 may be restricted by the locking device 160 with a simple motion of closing the front panel 140 after the water tank unit 130 is stored.

Herein, a lock state of the locking device 160 is described to be automatically cancelled during a process of pulling out the water tank unit 130. However, an embodiment of the present invention is not limited to such an arrangement. A structure and a location of the locking device 160 may vary. For example, an operating portion (not shown) may be formed on one of the air washer body 110 and the front panel 140 to cancel the lock state of the locking device 160. The operating portion may include a press button, a rotary knob, and a slider. Thus, the lock state of the locking device 160 may be cancelled by operating the operating portion before the water tank unit 130 is pulled out, whereby the front panel 140 may be opened.

FIGS. 5 through 8 are views illustrating modified examples of the air washer 100 of FIG. 1. FIGS. 5 through 8 illustrate modified examples of the front panel 140 of a hinged door type.

FIG. 5 is a right side view of an air washer 102. Referring to FIG. 5, a front panel 142 may be formed to cover the front surface portion of the air washer body 110, the front surface portion of the water tank unit 130, and the space S between the water tank unit 130 and the water tank storage portion 116. The front panel 142 may be formed to be rotatably opened and closed in a vertical direction.

The front surface of the air washer 100 of FIGS. 1 through 3 may be formed by the front panel 140 and the front surface portion of the water tank unit 130, whereas a front surface of the air washer 102 of FIG. 5 may be formed only by the front panel 142. Thus, an appearance of the front surface of the air washer 102 may be formed more simply, and a design of the front surface of the air washer 102 may be completely changed by replacing the front panel 142.

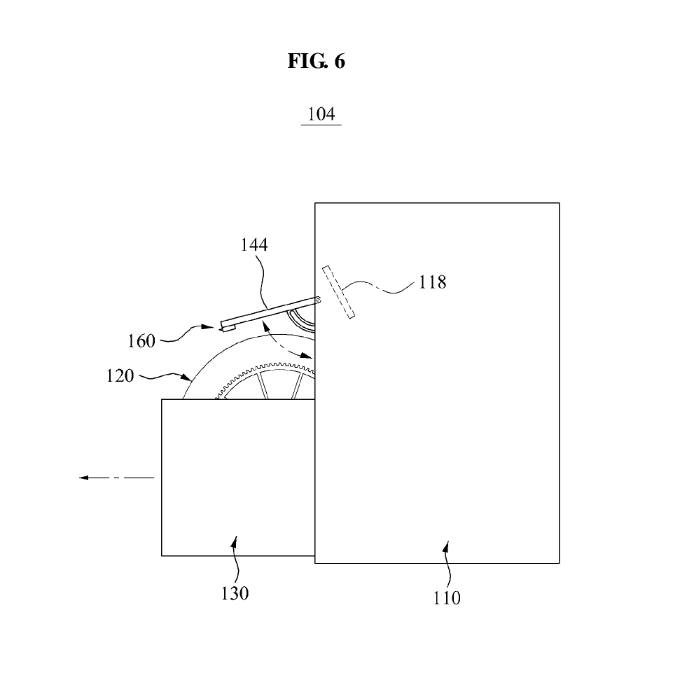

FIG. 6 is a right side view of an air washer 104. Referring to FIG. 6, a front panel 144 may be formed to cover the space S between the water tank unit 130 and the water tank storage portion 116. The front panel 144 may be formed to be rotatably opened and closed in a vertical direction.

The front surface of the air washer 100 of FIGS. 1 through 3 may be formed by the front panel 140 and the front surface portion of the water tank unit 130, whereas a front surface of the air washer 104 of FIG. 6 may be formed by the front panel 144, the front surface portion of the water tank unit 130, and the front surface portion of the air washer body 110.

The front panel 144 may be formed to have an area to shield the space S between the water tank unit 130 and the water tank storage portion 116. Thus, the front panel 144 may be formed to have a relatively smaller area than the front panel 140 of FIGS. 1 through 3. In this example, it may be impossible to form the air inlet 112 and the air guide 118 on the front panel 144. Thus, the air inlet 112 and the air guide 118 may be formed on the front surface portion of the air washer body 110, separately from the front panel 144.

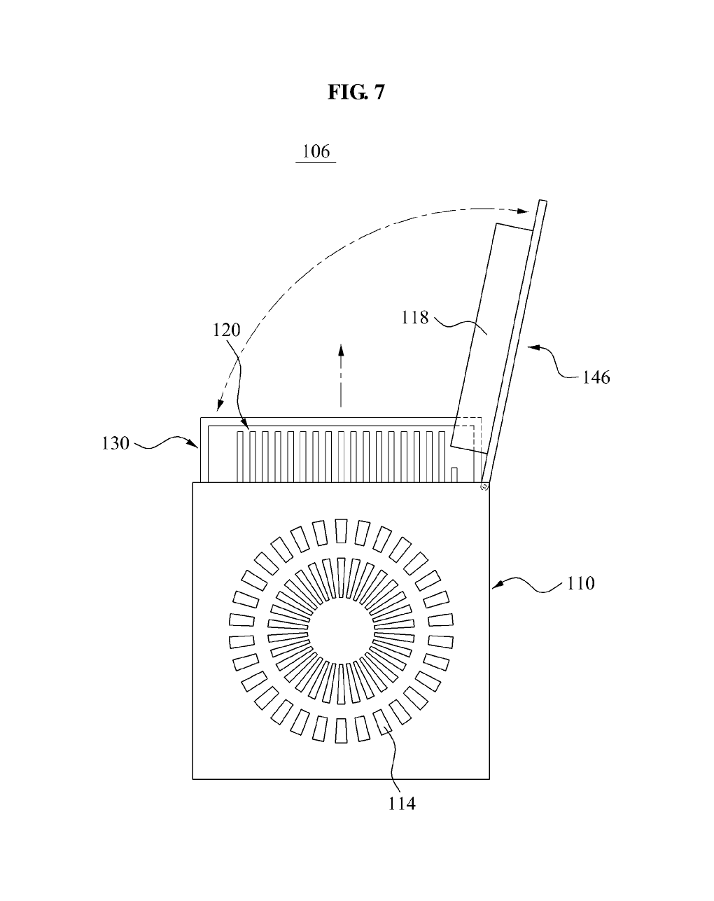

FIG. 7 is a top view of an air washer 106. Referring to FIG. 7, a front panel 146 may be formed to cover the front surface portion of the air washer body 110, and the space S between the water tank unit 130 and the water tank storage portion 116. The front panel 146 may be formed to be rotatably opened and closed in a horizontal direction.

The upper portion of the front panel 140 of FIGS. 1 through 3 may be rotatably connected to the upper portion of the front surface portion of the air washer body 110, whereas a side portion of the front panel 146 of FIG. 7 may be rotatably connected to a side portion of the front surface portion of the air washer body 110. Thus, an opening and closing direction of the front panel 146 may be suitably selected depending on a customer preference or a space in which the air washer 106 is to be provided.

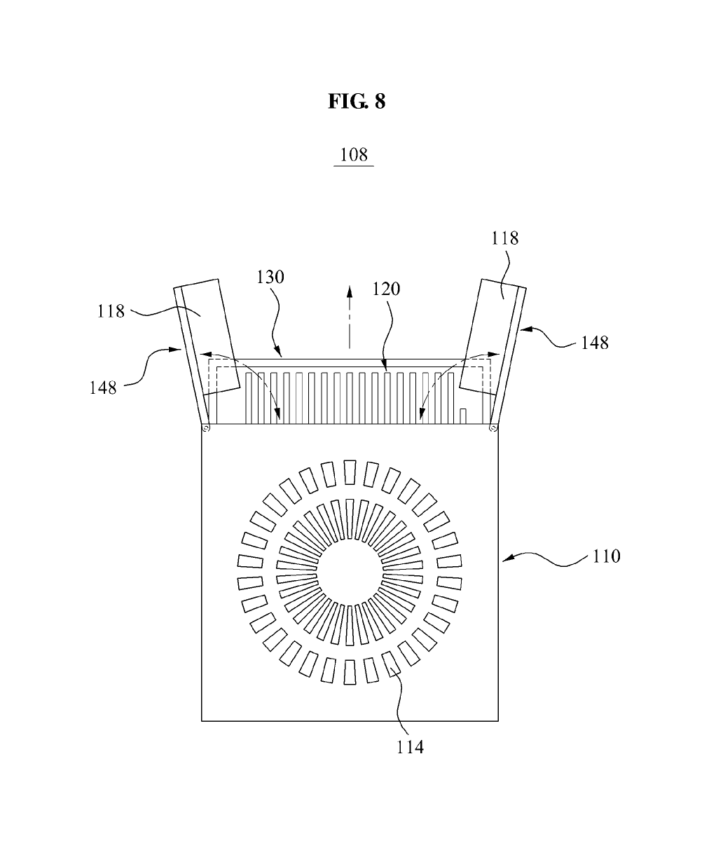

FIG. 8 is a top view of an air washer 108. Referring to FIG. 8, a front panel 148 may be formed to cover the front surface portion of the air washer body 110, and the space S between the water tank unit 130 and the water tank storage portion 116. A plurality of front panels 148 may be disposed on the front surface portion of the air washer body 110, and the front panels 148 may be formed to be rotatably opened and closed in a horizontal direction.

The upper portion of the front panel 140 of FIGS. 1 through 3 may be rotatably connected to the upper portion of the front surface portion of the air washer body 110, whereas side portions of the front panels 148 of FIG. 8 may be rotatably connected to both side portions of the front surface portion of the air washer body 110.

As described above, various examples of a front panel of a hinged door type, for example, the front panels 140, 142, 144, 146, and 148, are suggested. However, an embodiment of the present invention is not limited thereto, and may be variously modified depending on design conditions and situations thereof.

An operation and application effects of the air washer 100 will be described. Hereinafter, descriptions will be provided based on the air washer 100 of FIGS. 1 through 4.

When the air washer 100 is used for a long time, there may be a possibility of a water shortage or water contamination. When the air washer 100 is used for a long time, regular cleaning or maintenance of the water tank unit 130 and the disk assembly 120 may be required.

To refill the water tank unit 130 with water, replace water, clean and maintain the water tank unit 130, or clean and maintain the disk assembly 120, pulling out of the water tank unit 130 and the disk assembly 120 may be required.

An operation of the air washer 100 may be completely terminated. The water tank unit 130 may be pulled out in a frontward direction using the handle portion 138 of the water tank unit 130.

The water tank unit 130 may be pulled out in a frontward direction from the water tank storage portion 116 along with the disk assembly 120. In the interim, a lock state of the locking device 160 may be cancelled, and the front panel 140 may be opened. In detail, when the water tank unit 130 is pulled out in a forward direction, the lock state between the water tank body 132 and the locking device 160 may be cancelled and thus, the front panel 140 may be rotated in an opening direction thereof by the elastic force of the elastic member 150.

When the front panel 140 is maximally rotated, the water tank storage portion 116 may be completely opened and the water tank unit 130 and the disk assembly 120 may be smoothly pulled out.

When the water tank unit 130 and the disk assembly 120 are completely pulled out from the air washer body 110, the water tank unit 130 and the disk assembly 120 may be cleaned or maintained. Also, the water stored in the water receiving portion 136 of the water tank unit 130 may be drained and the water receiving portion 136 of the water tank unit 130 may be refilled with clean water.

The disk assembly 120 may be disposed in the water receiving portion 136 of the water tank unit 130, and the water tank unit 130 may be pushed into the water tank storage portion 116 of the air washer body 110.

When the water tank unit 130 and the disk assembly 120 are completely stored in the water tank storage portion 116, the front panel 140 may be rotated to the original location to shield the front surface portion of the air washer body 110 and the space S formed between the water tank unit 130 and the water tank storage portion 116.

When the front panel 140 is rotated to the original location, the locking device 160 provided on the front panel 140 may be stopped at the front surface portion of the water tank body 132, and the location of the front panel 140 may be fixed. The operation of the front panel 140 may be restricted by the locking device 160 at the location to shield the front surface portion of the air washer body 110 and the space S formed between the water tank unit 130 and the water tank storage portion 116.

Thus, in the air washer 100, the water tank unit 130 and the disk assembly 120 may be conveniently and quickly pulled out in the frontward direction of the air washer body 110. The water tank unit 130 may be conveniently refilled with water, and the water tank unit 130 and the disk assembly 120 may be conveniently cleaned or maintained.

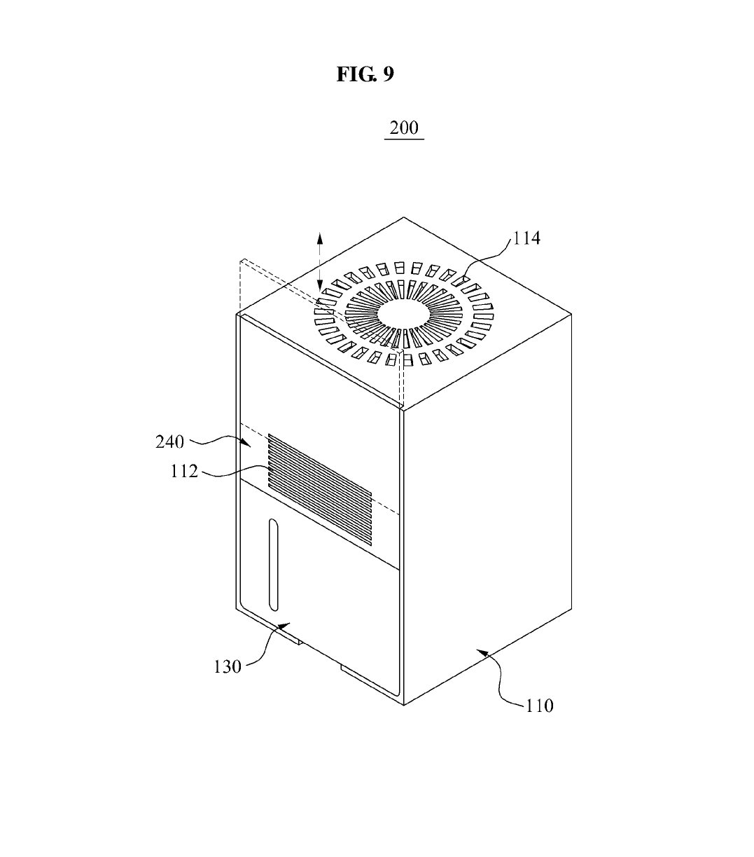

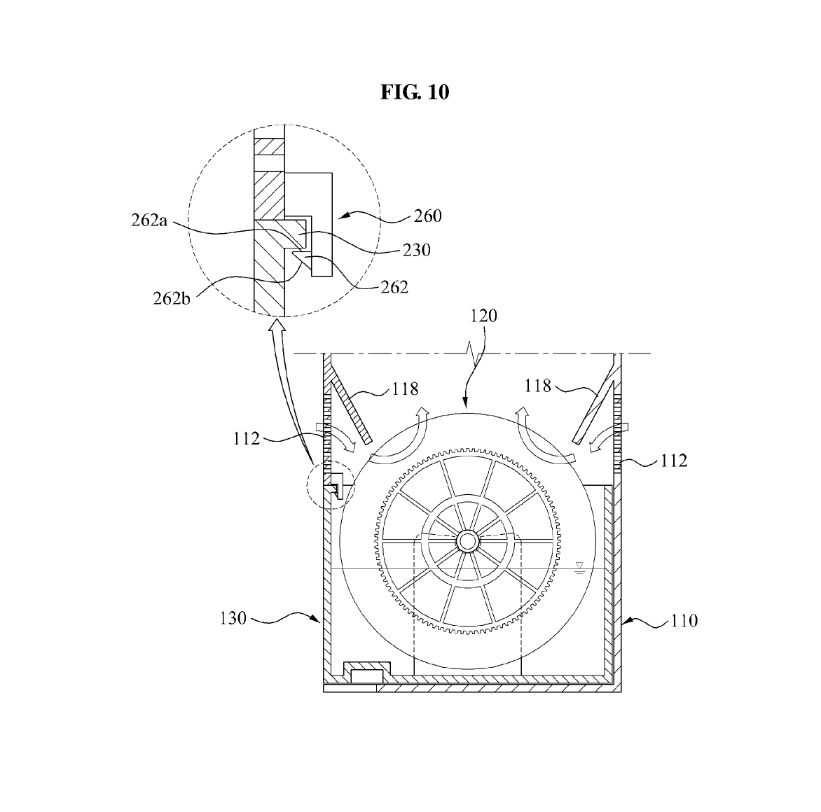

FIG. 9 is a perspective view illustrating an air washer 200 according to another embodiment of the present invention, and FIG. 10 is a right cross-sectional view illustrating a lower portion of the air washer 200 of FIG. 9.

In FIGS. 1 through 3, 9, and 10, like reference numerals refer to the like elements and thus, duplicated descriptions on the like elements will be omitted for conciseness. Hereinafter, differences between the air washer 100 and the air washer 200 will be described.

Referring to FIGS. 9 and 10, the air washer 200 may differ from the air washer 100 in that a front panel 240 may be provided in a sliding door type to be slidingly opened and closed.

The front panel 240 may be provided in the sliding door type on the front surface portion of the air washer body 110, and may be movably opened and closed in a vertical direction. The front panel 240 may be disposed on the front surface portion of the air washer body 110 to be slidingly moved in a vertical direction. A connection structure between the front panel 240 and the air washer body 110 may correspond to a general sliding movement structure.

The front panel 240 may be moved in an upward direction along the front surface portion of the air washer body 110 to completely open the water tank storage portion 116 when the water tank unit 130 is pulled out. The front panel 240 may be moved in a downward direction along the front surface portion of the air washer body 110 to completely shield the space S formed between the water tank unit 130 and the water tank storage portion 116 when the water tank unit 130 is stored. Thus, a travel distance of the front panel 240 may be set to be greater than a height of the space S formed between the water tank unit 130 and the water tank storage portion 116.

The air washer 200 may include an elastic member (not shown) to provide an elastic force to the front panel 240 in an opening direction of the front panel 240, and a locking device 260 to restrict the front panel 240 while the space S formed between the water tank unit 130 and the water tank storage portion 116 is being shielded.

The elastic member may be configured using a compression spring provided between the front panel 240 and the air washer body 110 to provide the elastic force to the front panel 240 in an upward direction. One end of the coil spring may be connected to a rear surface of the front panel 240, and another end of the coil spring may be connected to the front surface portion of the air washer body 110.

The locking device 260 may be provided on the rear surface of the front panel 240. For example, the locking device 260 may be configured using a hook 262 to be stopped by a stopper protrusion 230 formed at a top end portion of the front surface portion of the water tank unit 130 when the water tank unit 130 is stored. The hook 262 may be formed to be elastically pressed. A stopper surface 262a may be formed on one side of the hook 262. The stopper surface 262a may be stopped at the stopper protrusion 230 of the water tank body 132 while the water tank unit 130 is being stored. An inclined surface 262b may be formed on another side of the hook 262. The inclined surface 262b may elastically run over the stopper protrusion 230 of the water tank body 132 when the front panel 240 is moved downward to the front surface portion of the air washer body 110 after the water tank unit 130 is stored.

As described above, the front panel 240 may be slidingly moved in a vertical direction. Thus, the front panel 240 may be used although an obstacle exists in front of the air washer 200, when compared to the front panel 140 of FIGS. 1 through 3.

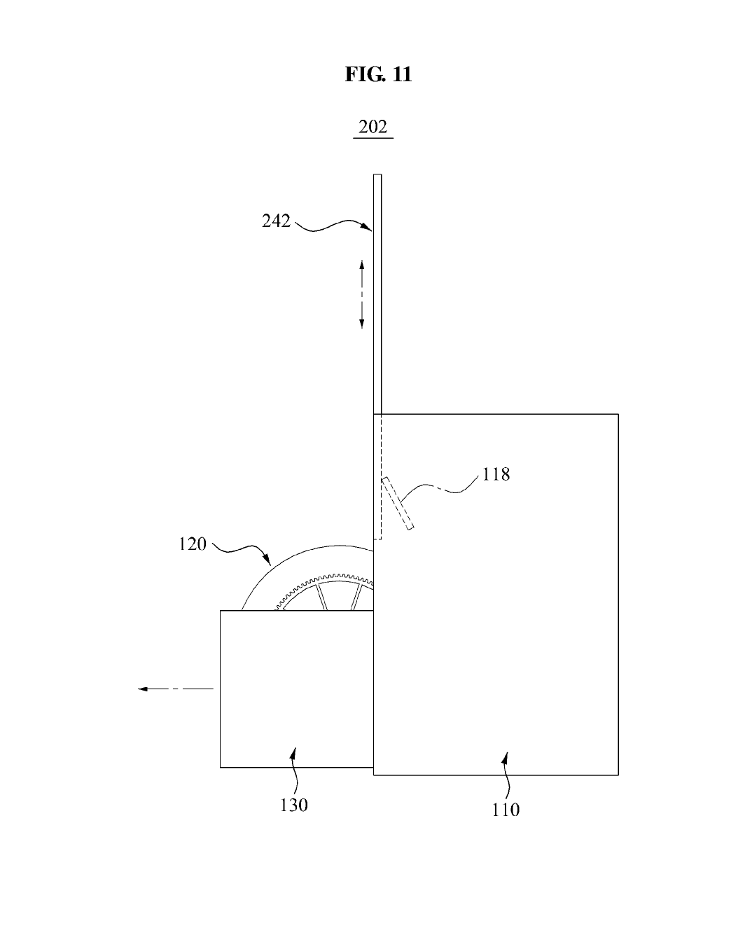

FIGS. 11 through 14 are views illustrating modified examples of the air washer 200 of FIG. 9. FIGS. 11 through 14 illustrate modified examples of the front panel 240 of a sliding door type.

FIG. 11 is a right side view of an air washer 202. Referring to FIG. 11, a front panel 242 may be formed to cover the front surface portion of the air washer body 110, the front surface portion of the water tank unit 130, and the space S between the water tank unit 130 and the water tank storage portion 116. The front panel 242 may be formed to be movably opened and closed in a vertical direction.

The front surface of the air washer 200 of FIG. 9 may be formed by the front panel 240 and the front surface portion of the water tank unit 130, whereas a front surface of the air washer 202 of FIG. 11 may be formed only by the front panel 242.

Thus, an appearance of the front surface of the air washer 202 may be formed more simply, and a design of the front surface of the air washer 202 may be completely changed by replacing the front panel 242.

In this example, an upward travel distance of the front panel 242 when the water tank storage portion 116 is opened may greatly increase. Thus, a risk of interference of the air guide 118 may be relatively high, and it may be impossible to form the air guide 118 on the front panel 242. Accordingly, the air guide 118 may be formed on the front surface portion of the air washer body 110.

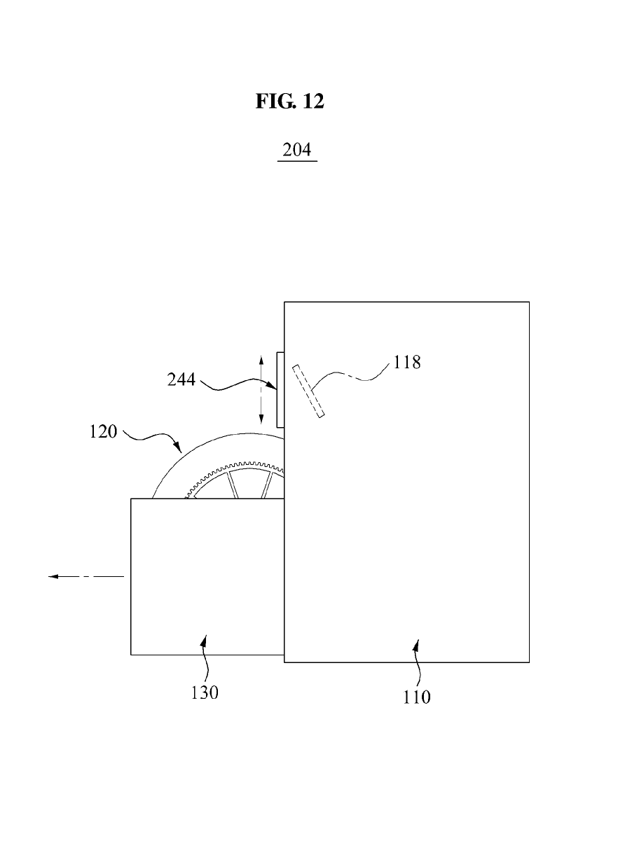

FIG. 12 is a right side view of an air washer 204. Referring to FIG. 12, a front panel 244 may be formed to cover the space S between the water tank unit 130 and the water tank storage portion 116. The front panel 244 may be formed to be movably opened and closed in a vertical direction.

The front surface of the air washer 200 of FIG. 9 may be formed by the front panel 240 and the front surface portion of the water tank unit 130, whereas a front surface of the air washer 204 of FIG. 12 may be formed by the front panel 244, the front surface portion of the water tank unit 130, and the front surface portion of the air washer body 110. The front panel 244 may be formed to have an area to shield the space S between the water tank unit 130 and the water tank storage portion 116. Thus, the front panel 244 may be formed to have a relatively smaller area than the front panel 240 of FIG. 9.

The front panel 244 may be formed to be slidingly moved in a vertical direction on the front surface portion of the air washer body 110. Thus, the front panel 244 may be disposed in front of the front surface portion of the air washer body 110 or the front surface portion of the water tank unit 130. For example, when the front panel 244 is moved in an upward direction, the front panel 244 may be slidingly moved along the front surface portion of the air washer body 110. When the front panel 244 is moved in an upward direction, the front panel 244 may be in close contact with the front surface portion of the air washer body 110.

In this example, it may be impossible to form the air guide 118 on the rear surface of the front panel 244. Thus, the air guide 118 may be formed on the front surface portion of the air washer body 110, separately from the front panel 244.

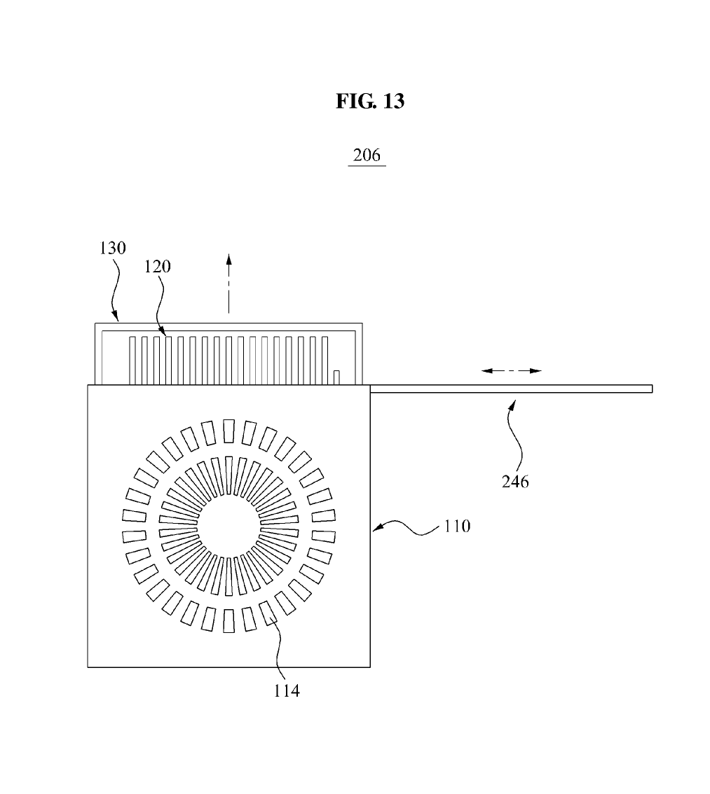

FIG. 13 is a top view of an air washer 206. Referring to FIG. 13, a front panel 246 may be formed to cover the front surface portion of the air washer body 110, and the space S between the water tank unit 130 and the water tank storage portion 116. The front panel 246 may be formed to be movably opened and closed in a horizontal direction. Both side portions of the front panel 240 of FIG. 9 may be connected to both side portions of the front surface portion of the air washer body 110 to be slidingly moved in a vertical direction, whereas an upper portion and a lower portion of the front panel 246 of FIG. 13 may be connected to an upper portion and a lower portion of the front surface portion of the air washer body 110 to be slidingly moved in a horizontal direction. Thus, an opening and closing direction of the front panel 246 may be suitably selected depending on a customer preference or a space in which the air washer 206 is to be provided.

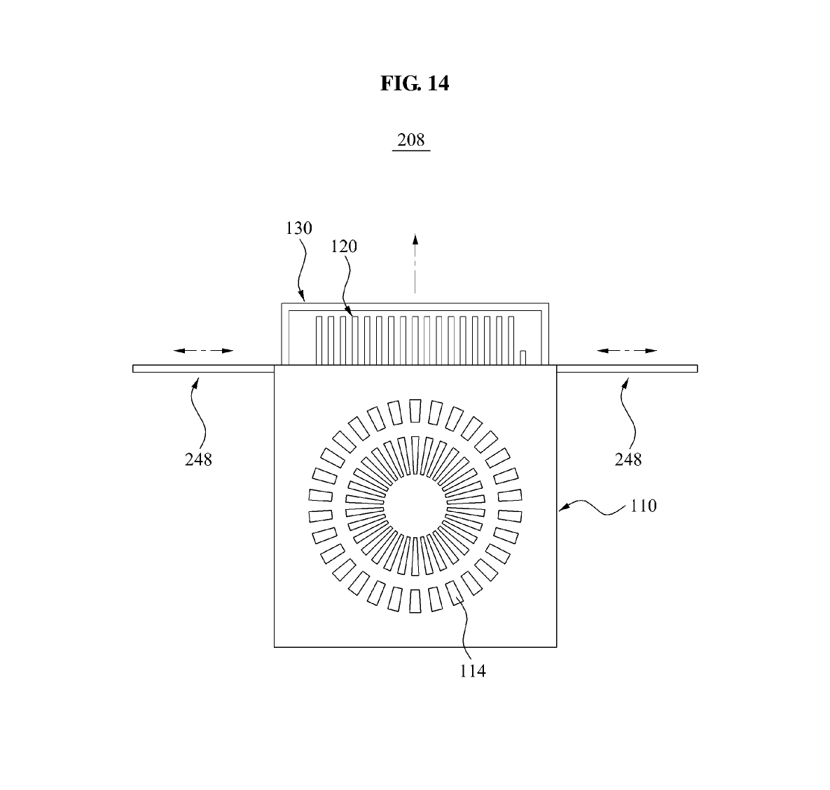

FIG. 14 is a top view of an air washer 208. Referring to FIG. 14, a front panel 248 may be formed to cover the front surface portion of the air washer body 110 and the space S between the water tank unit 130 and the water tank storage portion 116. A plurality of front panels 248 may be disposed on the front surface portion of the air washer body 110, and the front panels 248 may be formed to be movably opened and closed in a horizontal direction.

Both side portions of the front panel 240 of FIG. 9 may be connected to both side portions of the front surface portion of the air washer body 110 to be slidingly moved in a vertical direction, whereas upper portions and lower portions of the front panels 248 of FIG. 14 may be connected to an upper portion and a lower portion of the front surface portion of the air washer body 110 to be slidingly moved in a horizontal direction. The front panels 248 may be disposed on both sides of the front surface portion of the air washer body 110.

As described above, various examples of a front panel of a sliding door type, for example, the front panels 240, 242, 244, 246, and 248, are suggested. However, an embodiment of the present invention is not limited thereto, and may be variously modified depending on design conditions and situations thereof.

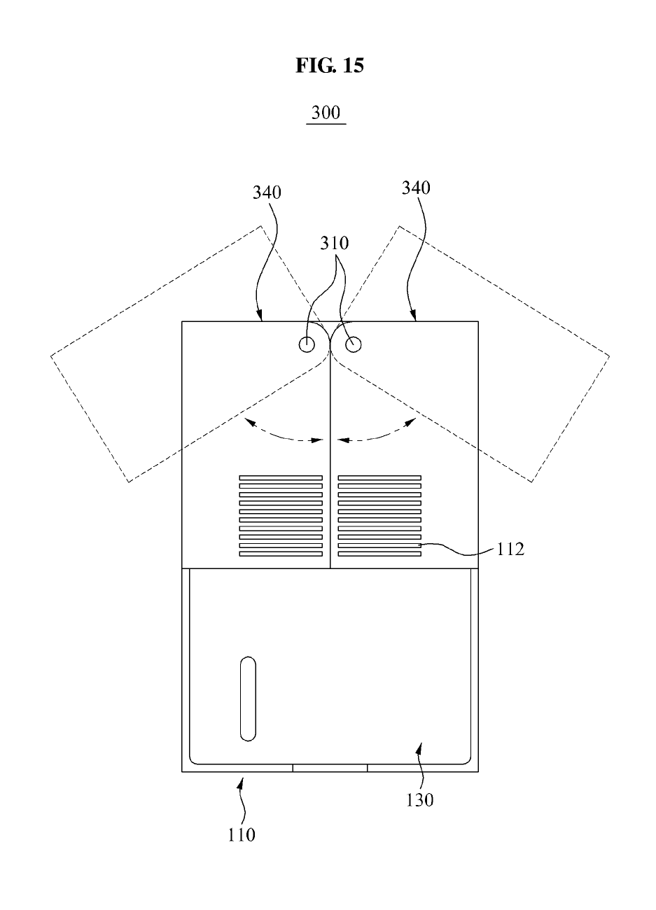

FIG. 15 is a front view illustrating an air washer 300 according to still another embodiment of the present invention.

In FIGS. 1 through 3, and 15, like reference numerals refer to the like elements and thus, duplicated descriptions on the like elements will be omitted for conciseness. Hereinafter, differences between the air washer 100 and the air washer 300 will be described.

Referring to FIG. 15, the air washer 300 may differ from the air washer 100 in that a front panel 340 may be provided in a clock type to be opened and closed in a manner of a clock.

The front panel 340 may be provided in a clock type on the front surface portion of the air washer body 110, and may be rotatably opened and closed in a clockwise or counterclockwise direction. The front panel 340 may be disposed to rotate on one side of the front surface portion of the air washer body 110. Accordingly, a pivot 310 may be provided on the front surface portion of the air washer body 110, and the front panel 340 may be connected to the pivot 310.

The front panel 340 may rotate on the pivot 310 of the air washer body 110 to completely open the water tank storage portion 116 when the water tank unit 130 is pulled out. The front panel 340 may rotate until the front panel 340 is away from a pulling-out path of the water tank unit 130 and the disk assembly 120.

A plurality of front panels 340 may be disposed on the front surface portion of the air washer body 110. Hereinafter, front panels 340 will be described to be rotatably disposed on both sides of the front surface portion of the air washer body 110.

The air washer 300 may include an elastic member (not shown) to provide an elastic force to the front panel 340 in an opening direction of the front panel 340, and a locking device (not shown) to restrict the front panel 340 while the space S formed between the water tank unit 130 and the water tank storage portion 116 is being shielded. For example, the elastic member may be configured using a torsion spring provided on the pivot 310 of the air washer body 110, or a compression spring provided between the air washer body 110 and the front panel 340. The locking device may be provided on a rear surface of the front panel 340. The locking device may be configured using a hook to be stopped by a stopper protrusion formed at a top end portion of the front surface portion of the water tank unit 130 when the water tank unit 130 is stored.

As described above, the front panel 340 of FIG. 15 may rotate in a clockwise direction or a counterclockwise direction. Thus, the front panel 240 may be used although an obstacle exists in front of and above the air washer 300.

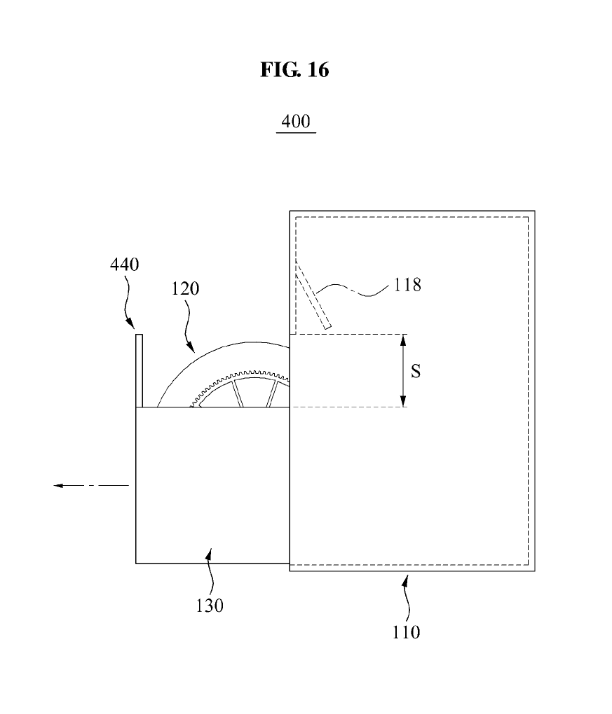

FIG. 16 is a side view illustrating an air washer 400 according to yet another embodiment of the present invention.

In FIGS. 1 through 3, and 16, like reference numerals refer to the like elements and thus, duplicated descriptions on the like elements will be omitted for conciseness. Hereinafter, differences between the air washer 100 and the air washer 400 will be described.

Referring to FIG. 16, the air washer 400 may differ from the air washer 100 in that the front panel 140 may be omitted, and a shielding panel 440 may be provided to shield the space S between the water tank unit 130 and the water tank storage portion 116.

The shielding panel 440 is a member provided in a form of a panel protruding in an upward direction on the front surface portion of the water tank body 132 of the water tank unit 130. The shielding panel 440 may be formed to have a height and an area to shield the space S between the water tank unit 130 and the water tank storage portion 116 when the water tank unit 130 is stored. Thus, by applying the shielding panel 440 to the water tank unit 130, the space S between the water tank unit 130 and the water tank storage portion 116 may be shielded when the water tank unit 130 is stored.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An air washer, comprising:
an air washer body comprising an air inlet and an air outlet;
an air blowing unit provided in an internal portion of the air washer body to draw in air through the air inlet and exhaust air through the air outlet;
a disk assembly disposed on an air flow path between the air inlet and the air outlet to humidify and wash the air drawn in by the air blowing unit; and
a water tank unit comprising a water receiving portion in which the disk assembly is disposed to be movable, and provided in a lower portion of the air washer body to be pulled out in a frontward direction of the air washer body.

2. The air washer of claim 1, wherein a water tank storage portion opening in a frontward direction is formed in the lower portion of the air washer body, and the water tank unit is disposed to be slidingly moved in the water tank storage portion.

3. The air washer of claim 2, wherein the disk assembly is formed in a size to enable a portion thereof to be exposed in an upper portion of the water tank unit, and
the water tank storage portion is formed in a size to prevent interference with the disk assembly when the water tank unit is pulled out and stored.

4. The air washer of claim 3, further comprising:
a shielding panel formed to protrude on a front surface portion of the water tank unit to shield a space between the water tank unit and the water tank storage portion.

5. The air washer of claim 3, further comprising:
a front panel provided to be rotatable or movable on a front surface portion of the air washer body,
wherein the front panel is disposed on the front surface portion of the air washer body to form a front surface of the air washer when the water tank unit is stored, and is rotated or moved to a location to completely open the water tank storage portion when the water tank unit is pulled out.

6. The air washer of claim 5, wherein the front panel is provided in a hinged door type on the front surface portion of the air washer body, and is rotatably opened and closed in a vertical direction or a horizontal direction.

7. The air washer of claim 5, wherein the front panel is provided in a sliding door type on the front surface portion of the air washer body, and is movably opened and closed in a vertical direction or a horizontal direction.

8. The air washer of claim 5, wherein the front panel is provided in a clock type on the front surface portion of the air washer body, and is rotatably opened or closed in a clockwise direction or a counterclockwise direction.

9. The air washer of claim 5, wherein the front panel is formed to cover the front surface portion of the air washer body, a front surface portion of the water tank unit, and a space between the water tank unit and the water tank storage portion.

10. The air washer of claim 5, wherein the front panel is formed to cover the front surface portion of the air washer body, and a space between the water tank unit and the water tank storage portion.

11. The air washer of claim 5, wherein the front panel is formed to cover a space between the water tank unit and the water tank storage portion when the water tank unit is stored.

12. The air washer of claim 5, wherein a single front panel or a plurality of front panels is disposed on the front surface portion of the air washer body.

13. The air washer of claim 5, further comprising:
an elastic member provided on the front panel and the air washer body to provide an elastic force to the front panel in an opening direction of the front panel; and
a locking device provided on the front panel to lock the front panel on the front surface portion of the air washer body.

14. The air washer of claim 13, wherein the locking device is formed to cancel a lock state in response to a movement of the water tank unit when the water tank unit is pulled out.

15. The air washer of claim 13, wherein the locking device is formed to cancel a lock state by operating an operating portion formed on the air washer body or the front panel before the water tank unit is pulled out.

16. The air washer of claim 5, wherein the air inlet is formed on both a rear surface portion of the air washer body and the front panel, and the air outlet is formed on a top surface portion of the air washer body, and
an air guide is formed on the front panel and the rear surface portion of the air washer body to guide the air drawn in through the air inlet to the disk assembly.

17. An air washer, comprising:
an air washer body to humidify and wash air;
a water tank unit disposed in a lower portion of the air washer body to be pulled out in a frontward direction of the air washer body, and comprising a water receiving portion to receive water to be used to wash air; and
a front panel disposed on a front surface portion of the air washer body, and provided to be rotated or moved to a location away from a pulling-out path of the water tank unit when the water tank unit is pulled out.

18. The air washer of claim 17, further comprising:
a disk assembly disposed on an air flow path in an internal portion of the air washer body,
wherein the disk assembly is disposed to be rotatable in the water receiving portion, and is pulled out in the frontward direction of the air washer body along with the water tank unit.

19. The air washer of claim 17, wherein a water tank storage portion opening in a frontward direction is formed in a lower portion of the air washer body,
the water tank unit is disposed to be slidingly moved in the water tank storage portion, and
the front panel is formed to open and close the water tank storage portion.

20. The air washer of claim 19, wherein the front panel is provided in at least one of a hinged door type, a sliding door type, and a clock type on the front surface portion of the air washer body to open and close the water tank storage portion.

21. The air washer of claim 20, wherein at least one of an air inlet and an air outlet is formed on the front panel, and
an air guide is formed on a rear surface of the front panel to guide air drawn in through the air inlet or air to be exhausted through the air outlet.
